(19) United States
(12) Patent Application Publication
(10) Pub. No.: US 2012/0070570 A1
(43) Pub. Date: Mar. 22, 2012

(54) CONDUCTIVE THICK METAL ELECTRODE FORMING METHOD

(75) Inventors: Woo Soo KIM, Coquitlam (CA); Ping LIU, Mississauga (CA); Yiliang WU, Mississauga (CA); Nan-Xing HU, Oakville (CA)

(73) Assignee: XEROX CORPORATION, Norwalk, CT (US)

(21) Appl. No.: 12/883,936

(22) Filed: Sep. 16, 2010

(51) Int. Cl. B05D 3/02; B05D 5/00

(52) U.S. Cl. 427/192; 427/191

(57) ABSTRACT

A method of forming conductive features on a substrate, the method includes, filling a flexible stamp with a metal nanoparticle composition, depositing the metal nanoparticle composition onto the substrate, and heating the deposited metal nanoparticle composition during or after the depositing to form the conductive features.

### BACKGROUND

Fabrication of electronic circuit elements using liquid deposition techniques is of profound interest as such techniques provide potentially low-cost alternatives to conventional mainstream amorphous silicon technologies for electronic applications such as thin film transistors (TFTs), light-emitting diodes (LEDs), RFID tags, photovoltaics, and the like.

Solution-processable conductors are of great interest for use in such electronic applications. Silver nanoparticle-based inks represent a promising class of materials for printed electronics. However, most silver (and gold) nanoparticles often require large molecular weight stabilizers to ensure proper solubility and stability in solution. These large molecular weight stabilizers inevitably raise the annealing temperatures of the silver nanoparticles above 200° C. in order to burn off the stabilizers, which temperatures are incompatible with some low-cost plastic substrates such as polyethylene terephthalate (PET) and polyethylene naphthalate (PEN) that the solution may be coated onto and can cause damage thereto.

While currently available methods for preparing conductive elements for electronic devices are suitable for their intended purposes, there remains a need for a method suitable for preparing conductive structures using stable metal nanoparticle compositions, the conductive features having a thickness of several micrometers, a high aspect ratio and a low annealing temperature.

### SUMMARY

There is therefore a need, addressed by the subject matter disclosed herein, for a method of forming conductive features, such as metal electrodes, having a thickness of several micrometers, a high aspect ratio and annealing (post-processing) of the metal nanoparticles at temperatures below at least about 200° C.

The above and other issues are addressed by the present application, wherein in embodiments, a method of forming conductive features on a substrate, the method comprising: filling a flexible stamp with a metal nanoparticle composition, depositing the metal nanoparticle composition onto the substrate, and heating the deposited metal nanoparticle composition during or after the depositing to form the conductive features.

In embodiments, described is a method of forming conductive features on a substrate, the method comprising: filling a flexible stamp with a metal nanoparticle composition comprised of organic-stabilized metal nanoparticles and a solvent, depositing the metal nanoparticle composition onto the substrate, and heating the deposited metal nanoparticle composition during or after the depositing to a temperature of from about 80° C. to about 200° C. to form the conductive features.

### EMBODIMENTS

The present process is a method of forming conductive features, in embodiments metal features, on a substrate. The method comprises filling the flexible stamp with a metal nanoparticle composition. In embodiments, the metal nanoparticle composition is comprised of metal nanoparticles, a stabilizer and solvent. The metal nanoparticle composition is then deposited onto the substrate and the deposited solution is heated to form the conductive features on the substrate. The method is particularly convenient for preparing low temperature processable metal nanoparticles having an annealing temperature of, for example, about 200° C. or less, a high aspect ratio and/or where low annealing temperature required for conductive features having thickness from to several micrometers to over 10 micrometers.

Flexible Stamp

In embodiments, a flexible stamp or mold is prepared to house the metal nanoparticle composition. The flexible stamp functions as a container for the metal nanoparticle composition and corresponds to the pattern for conductive features formed on the substrate. The mold may be prepared via any suitable technique, such as photolithography, e-beam lithography, or micro-machining.

The flexible stamp may be fabricated by first forming a master on a mold substrate, such as glass, silicon wafer, polyethylene terephthalate (PET), PEN, and the like. A flexible material is then placed over the master, and cured using heat or ultraviolet light. Upon removal, the flexible stamp is the exact structural inverse, or “relief”, of the master and thus will have the inverted structural features of the master. Each of the structural features discussed below can thus be imparted as a relief feature or pattern to the flexible stamp from the master. Thus, the flexible stamp includes a relief of the conductive feature pattern formed on the substrate, the conductive feature pattern being substantially similar to the pattern of the master.

The surface of the master may be a textured surface such that it may be nano- or micro-structured surface having various or irregular topographies, such as periodic and/or ordered nano-, micro-, or nano-micro-surface features. For example, the structural features of the master may have protrusive or intrusive features having irregular or regular shapes. Examples of regular shapes include a circle, a rectangle, an oval, a square, a triangle, a polygon and combinations thereof.

The structural features of the master may also have a width of from about 1 μm to about 1 mm, from about 1 μm to about 100 μm, from about 1 μm to about 75 μm and from about 1 μm to about 50 μm.

The structural features of the master may also have a depth of at least 500 nm, such as from about 500 nm to about 10 μm, from about 1 μm to about 5 μm and from about 2 μm to about 5 μm. In view of the above, the aspect ratio (the depth/width) for the flexible stamp may be from about 3:100 to about 2:1, from about 1:20 to about 1:1, from about 1:10 to about 1:2 and from about 3:100 to about 1:5.

The structural features of the master may also be periodically ordered structural features and can form arrays. The arrays of the periodically ordered structural features can include, for example, a hexagonal array, a tetragonal array, a quasi-crystal array, a line array, a dot array, and combinations thereof.

The mold substrate, used to support the master pattern, may be made of a material selected from the group consisting of a metal, a polymer, a glass, ceramic and wood. A release agent may also be applied to the mold to facilitate the removal of the flexible stamp from the master pattern. Examples of release agents include fluorinated compounds such as fluorinated carboxylic acids, thiols, amines; and hydrocarbon compounds such as thiols, carboxylic acids, amines and the like.

The flexible material for the flexible stamp may be made of a material selected from the group consisting of polysiloxane, polyurethane, polyester, fluoro elastomer, silicon elastomer, fluorinated polymers, and mixtures thereof. The flexible stamp may also be urethane having a curable group. The curable group for the urethane may be selected from the group consisting of an acrylate, methacrylate, alkene, allylic ether, epoxide and oxetane.

Examples of flexible materials for the flexible stamp may include Ebecryl230, Ebecryl244, Ebecryl245, Ebecryl270, Ebecryl280/15IB, Ebecryl284, Ebecryl285, Ebecryl4830, Ebecryl4835, Ebecryl4858, Ebecryl4883, Ebecryl8402, Ebecryl8803, Ebecryl8800, Ebecryl254, Ebecryl264, Ebecryl265, Ebecryl294/35HD, Ebecryl1259, Ebecryl1264, Ebecryl4866, Ebecryl9260, Ebecryl8210, Ebecryl1290, Ebecryl1290K, Ebecryl5129, Ebecryl2000, Ebecryl2001, Ebecryl2002, Ebecryl2100, KRM7222, KRM7735, KRM4842, KRM210, KRM215, KRM4827, KRM4849, KRM6700, KRM6700-20T, KRM204, KRM205, KRM6602, KRM220, KRM4450, KRM770, IRR567, IPR81, IPR84, IPR83, IPR80, IPR657, IPR800, IPR805, IPR808, IPR810, IPR812, IPR1657, IPR1810, IRR302, IPR450, IPR670, IPR830, IPR835, IPR870, IPR1830, IPR1870, IPR2870, IRR267, IPR813, IRR483, IPR811, IPR436, IPR438, IPR446, IPR505, IPR524, TPR525, IPR554W, IPR584, IPR586, IPR745, IPR767, IPR1701, IPR1755, IPR740/40TP, IPR600, IPR601, IPR604, IPR605, IPR607, IPR608, IPR609, IPR600/25TO, IPR616, IPR645, IPR648, TPR860, IPR1606, IPR1608, IPR1629, IPR1940, IPR2958, IPR2959, IPR3200, IPR3201, IPR3404, IPR3411, IPR3412, IPR3415, IPR3500, IPR3502, IPR3600, IPR3603, IPR3604, TPR3605, IPR3608, IPR3700, IPR3700-20H, IPR3700-20T, IPR3700-25R, TPR3701, IPR3701-20T, IPR3703, IPR3702, RDX63182, RDX6040 and IRR419 manufactured by Daicel-UCB Co., Ltd.; CN104, CN120, CN124, CN136, CN151, CN2270, CN2271E, CN435, CN454, CN970, CN971, CN972, CN9782, CN981, CN9893 and CN991 manufactured by Sartomer Company; Laromer EA81, Laromer LR8713, Laromer LR8765, Laromer LR8986, Laromer PE56F, Laromer PE44F, Laromer LR8800, Laromer PE46T, Laromer LR8907, Laromer P043F, Laromer P077F, Laromer PE55S, Laromer LR8967, Laromer LR8981, Laromer LR8982, Laromer LR8992, Laromer LR9004, Laromer LR8956, Laromer LR8985, Laromer LR8987, Laromer UP35D, Laromer UA19T, Laromer LR9005, Laromer PO83F, Laromer PO33F, Laromer PO84F, Laromer PO94F, Laromer LR8863, Laromer LR8869, Laromer LR8889, Laromer LR8997, Laromer LR8996, Laromer LR9013, Laromer LR9019, Laromer PO9026V and Laromer PE9027V manufactured by BASF Co.; PHOTOMER 3005, PHOTOMER 3015, PHOTOMER 3016, PHOTOMER 3072, PHOTOMER 3982, 3215, PHOTOMER 5010, PHOTOMER 5429, PHOTOMER 5430, PHOTOMER 5432, PHOTOMER 5662, PHOTOMER 5806, PHOTOMER 5930, PHOTOMER 6008, PHOTOMER 6010, PHOTOMER 6019, PHOTOMER 6184, PHOTOMER 6210, PHOTOMER 6217, PHOTOMER 6230, PHOTOMER 6891, PHOTOMER 6892, PHOTOMER 6893-20R, PHOTOMER 6363, PHOTOMER 6572 and PHOTOMER 3660 manufactured by Cognis Co.; ART RESIN UN-9000HP, ART RESIN UN-9000PEP, ART RESIN UN-9200A, ART RESIN UN-7600, ART RESIN UN-5200, ART RESIN UN-1003, ART RESIN UN-1255, ART RESIN UN-3320HA, ART RESIN UN-3320HB, ART RESIN UN-3320HC, ART RESIN UN-3320HS, ART RESIN UN-901T, ART RESIN UN-1200TPK, ART RESIN UN-6060PTM and ART RESIN UN-6060P manufactured by Negami Chemical Industrial Co., Ltd.; SHIKOH UV-6630B, SHIKOH UV-7000B, SHIKOH UV-7510B, SHIKOH UV-7461TE, SHIKOH UV-3000B, SHIKOH UV-3200B, SHIKOH UV-3210EA, SHIKOH UV-3310B, SHIKOH UV-3500BA, SHIKOH UV-3520TL, SHIKOH UV-3700B, SHIKOH UV-6100B, SHIKOH UV-6640B, SHIKOH UV-1400B, SHIKOH UV-1700B, SHIKOH UV-6300B, SHIKOH UV-7550B, SHIKOH UV-7605B, SHIKOH UV-7610B, SHIKOH UV-7620EA, SHIKOH UV-7630B, SHIKOH UV-7640B, SHIKOH UV-2000B, SHIKOH UV-2010B, SHIKOH UV-2250EA and SHIKOH UV-2750B manufactured by Nippon Synthetic Chemical Industry Co., Ltd.; and KAYARAD R-280, KAYARAD R-146, KAYARAD R131, KAYARAD R-205, KAYARAD EX2320, KAYARAD R190, KAYARAD R130, KAYARAD R-300, KAYARAD C-0011, KAYARAD TCR-1234, KAYARAD ZFR-1122, KAYARAD UX-2201, KAYARAD UX-2301, KAYARAD UX3204, KAYARAD UX-3301, KAYARAD UX-4101, KAYARAD UX-6101, KAYARAD UX-7101, KAYARAD MAX-5101, KAYARAD MAX-5100, KAYARAD MAX-3510 and KAYARAD UX-4101 manufactured by Nippon Kayaku Co., Ltd.

The flexible material may also be a flexible material composition that includes a photoinitiator and a flexible material solvent.

In embodiments, a photoinitiator that absorbs radiation, for example UV light radiation, to initiate curing of the curable components of the flexible material composition. The term “curable” refers, for example, to the flexible material being polymerizable, that is, a material that may be cured via polymerization, including for example free radical routes, and/or in which polymerization is photoinitiated though use of a radiation sensitive photoinitiator. Thus, for example, the term “radiation curable” is intended to cover all forms of curing upon exposure to a radiation source, including light and heat sources and including in the presence or absence of initiators. Example radiation curing routes include curing using ultraviolet (UV) light, for example having a wavelength of 200-400 nm or more rarely visible light, such as in the presence of photoinitiators and/or sensitizers, curing using e-beam radiation, such as in the absence of photoinitiators, curing using thermal curing, in the presence or absence of high temperature thermal initiators (and which are generally largely inactive at the jetting temperature), and appropriate combinations thereof.

Examples of photoinitiators include benzophenones, benzoin ethers, benzilketals, α-hydroxyalkylphenones, α-aminoalkylphenones and acylphosphine photoinitiators sold under the trade designations of IRGACURE and DAROCUR from Ciba may be used. Specific examples include 2,4,6 trimethylbenzoyldiphenyl phosphine oxide (available as BASF LUCIRIN TPO); 2,4,6-trimethylbenzoylethoxyphenylphosphine oxide (available as BASF LUCIRIN TPO-L); bis(2,4,6-trimethylbenzoyl)-phenyl-phosphine oxide (available as Ciba IRGACURE 819) and other acyl phosphines; 2-methyl-1-(4-methylthio)phenyl-2-(4-morphorlinyl)-1-propanone (available as Ciba IRGACURE 907) and 1-(4-(2-hydroxyethoxy)phenyl)-2-hydroxy-2-methylpropan-1-one (available as Ciba IRGACURE 2959); 2-benzyl 2-dimethylamino 1-(4-morpholinophenyl)butanone-1 (available as Ciba IRGACURE 369); titanocenes; isopropylthioxanthone; 1-hydroxy-cyclohexylphenylketone; benzophenone; 2,4,6-trimethylbenzophenone; 4-methylbenzophenone; 2,4,6-trimethylbenzoylphenylphosphinic acid ethyl ester; oligo(2-hydroxy-2-methyl-1-(4-(1-methylvinyl)phenyl)propanone); 2-hydroxy-2-methyl-1-phenyl-1-propanone; benzyl-dimethylketal; 1-hydroxy-cyclohexyl-phenyl-ketone (available as Ciba IRGACURE 184), mixtures of oxy-phenyl-acetic acid 2-[2-oxo-2-phenyl-acetoxy-ethoxy]-ethyl ester and oxy-phenyl-acetic acid 2-[2-hydroxy-ethoxy]-ethyl ester (available as Ciba IRGACURE 754), a mixture of 25% bis(2,6-dimethoxybenzoyl)-2,4,4-trimethyl-pentylphosphineoxide and 75% 1-hydroxy-cyclohexyl-phenyl-ketone (available as Ciba IRGACURE 1800), 1-[4-(2-hydroxyethoxy)-phenyl]-2-hydroxy-2-methyl-1-propane-1-one (available as Ciba IRGACURE 2959) and 2-hydroxy-2-methyl-1-phenyl-propan-1-one (available as Ciba DAROCUR 1173) and mixtures thereof. This list is not exhaustive, and any known photoinitiator that initiates the free-radical reaction upon exposure to a desired wavelength of radiation such as UV light can be used without limitation.

In embodiments, the photoinitiator may absorb radiation of about 200 to about 420 nm wavelengths in order to initiate cure, although use of initiators that absorb at longer wavelengths, such as the titanocenes that may absorb up to 560 nm, can also be used without restriction.

The total amount of the photoinitiator included in the flexible material composition may be from, for example, about 0.5 to about 15% by weight, such as from about 1 to about 10% by weight, of the flexible material composition.

Specific examples of the solvent in the flexible material composition include γ-butyrolactone; ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; esters such as methyl lactate, ethyl lactate (EL), methyl acetate, ethyl acetate, butyl acetate, methyl pyruvate, ethyl pyruvate, methyl methoxypropionate, and ethyl ethoxypropionate; and propylene glycol monomethyl ether acetate (PGMEA).

Metal Nanoparticle Composition

In embodiments, the flexible stamp is filled with a metal nanoparticle composition. As used herein, the terms “fill” or “filled” are defined as locating the metal nanoparticle composition within the structural features of the flexible stamp. The locating of the metal nanoparticle composition within the structural features may be accomplished by capillary force, micro-injection, blanket coating followed by removing materials on relief structures, and the like.

The term “nano” as used in “metal nanoparticles” or “metal nanoparticle composition” refers to, for example, a particle size of less than about 1,000 nm, such as, for example, from about 0.5 nm to about 1,000 nm, for example, from about 1 nm to about 500 nm, from about 1 nm to about 100 nm, from about 1 nm to about 25 nm or from about 1 to about 10 nm. The particle size refers to the average diameter of the metal particles, as determined by TEM (transmission electron microscopy) or other suitable method. Generally, a plurality of particle sizes may exist in the metal nanoparticles obtained from the process described herein. In embodiments, the existence of different sized silver-containing nanoparticles is acceptable.

The metal nanoparticle composition herein includes metal nanoparticles (and if applicable, the stabilizer) in a liquid solution. In embodiments, the metal nanoparticles are composed of (i) one or more metals or (ii) one or more metal composites. Suitable metals may include, for example, Al, Ag, Au, Pt, Pd, Cu, Co, Cr, In, and Ni, particularly the transition metals, for example, Ag, Au, Pt, Pd, Cu, Cr, Ni, and mixtures thereof. Silver may be used as a suitable metal. Suitable metal composites may include Au—Ag, Ag—Cu, Ag—Ni, Au—Cu, Au—Ni, Au—Ag—Cu, and Au—Ag—Pd. The metal composites may also include non-metals, such as, for example, Si, C, and Ge. The various components of the metal composite may be present in an amount ranging, for example, from about 0.01% to about 99.9% by weight, particularly from about 10% to about 90% by weight. Furthermore, the composition described herein may not include any metal oxide nanoparticles.

In embodiments, the metal composite is a metal alloy composed of silver and one, two or more other metals, with silver comprising, for example, at least about 20% of the nanoparticles by weight, particularly greater than about 50% of the nanoparticles by weight.

In embodiments, the metal nanoparticle composition has a viscosity at least 10 cps, including from about 10 cps to about 5000 cps, from about 15 cps to about 2000 cps, as measured by rheology meter at room temperature at a low shear rate for example 1 per second.

Unless otherwise noted, the weight percentages recited herein for the components of the metal nanoparticles in the solution do not include the stabilizer.

The metal nanoparticles may be a mixture of two or more bimetallic metal nanoparticle species, such as those described in commonly assigned U.S. Patent Application Pub. No. 2009/0274834, which is incorporated herein by reference in its entirety, or a bimodal metal nanoparticle, such as those described in U.S. Patent Application Publication No. 2009/0301344, which is also incorporated herein by reference in its entirety.

If the metal nanoparticle is silver, the silver nanoparticles have a stability (that is, the time period where there is minimal precipitation or aggregation of the silver-containing nanoparticles) of, for example, at least about 1 day, or from about 3 days to about 1 week, from about 5 days to about 1 month, from about 1 week to about 6 months, from about 1 week to over 1 year.

The weight percentage of the metal nanoparticles in the metal nanoparticle composition is at least 50 weight percent, from about 50 weight percent to about 80 weight percent or from about 60 weight percent to about 70 weight percent.

Stabilizer

The composition described herein may also contain an organic stabilizer that is connected to the surface of the metal nanoparticles and is not removed until the annealing of the metal nanoparticles during formation of metal features on a substrate.

In embodiments, the stabilizer is physically or chemically associated with the surface of the metal nanoparticles. In this way, the nanoparticles have the stabilizer thereon outside of a liquid solution. That is, the nanoparticles with the stabilizer thereon may be isolated and recovered from a reaction mixture solution used in forming the nanoparticles and stabilizer complex. The stabilized nanoparticles may thus be subsequently readily and homogeneously dispersed in a solvent for forming a printable solution.

As used herein, the phrase “physically or chemically associated” between the metal nanoparticles and the stabilizer may be a chemical bond and/or other physical attachment. The chemical bond can take the form of, for example, covalent bonding, hydrogen bonding, coordination complex bonding, or ionic bonding, or a mixture of different chemical bonds. The physical attachment can take the form of, for example, van der Waals' forces or dipole-dipole interaction, or a mixture of different physical attachments.

The term “organic” in the phrase “organic stabilizer” or “organic-stabilized” refers to, for example, the presence of carbon atom(s), but the organic stabilizer may include one or more non-metal heteroatoms such as nitrogen, oxygen, sulfur, silicon, halogen, and the like. The organic stabilizer may be an organoamine stabilizer such as those described in U.S. Pat. No. 7,270,694, which is incorporated by reference herein in its entirety. Examples of the organoamine are an alkylamine, such as for example butylamine, pentylamine, hexylamine, heptylamine, octylamine, nonylamine, decylamine, hexadecylamine, undecylamine, dodecylamine, tridecylamine, tetradecylamine, diaminopentane, diaminohexane, diaminoheptane, diaminooctane, diaminononane, diaminodecane, diaminooctane, dipropylamine, dibutylamine, dipentylamine, dihexylamine, diheptylamine, dioctylamine, dinonylamine, didecylamine, methylpropylamine, ethylpropylamine, propylbutylamine, ethylbutylamine, ethylpentylamine, propylpentylamine, butylpentylamine, tributylamine, trihexylamine, and the like, or mixtures thereof.

Examples of other organic stabilizers include, for example, thiol and its derivatives, —OC(═S)SH (xanthic acid), polyethylene glycols, polyvinylpyridine, polyvinylpyrrolidone, and other organic surfactants. The organic stabilizer may be selected from the group consisting of a thiol such as, for example, butanethiol, pentanethiol, hexanethiol, heptanethiol, octanethiol, decanethiol, and dodecanethiol; a dithiol such as, for example, 1,2-ethanedithiol, 1,3-propanedithiol, and 1,4-butanedithiol; or a mixture of a thiol and a dithiol. The organic stabilizer may be selected from the group consisting of a xanthic acid such as, for example, O-methylxanthate, O-ethylxanthate, O-propylxanthic acid, O-butylxanthic acid, O-pentylxanthic acid, O-hexylxanthic acid, O-heptylxanthic acid, O-octylxanthic acid, O-nonylxanthic acid, O-decylxanthic acid, O-undecylxanthic acid, O-dodecylxanthic acid. Organic stabilizers containing a pyridine derivative (for example, dodecyl pyridine) and/or organophosphine that can stabilize metal nanoparticles may also be used as the stabilizer herein.

Further examples of organic stabilized metal nanoparticles may include: the carboxylic acid-organoamine complex stabilized metal nanoparticles, described in U.S. Patent Application Pub. No. 2009/0148600; the carboxylic acid stabilizer metal nanoparticles described in U.S. Patent Application Pub. No. 2007/0099357 A1, and the thermally removable stabilizer and the UV decomposable stabilizers described in U.S. Patent Application Pub. No. 2009/0181183, each of which is incorporated by reference herein in their entirety.

The extent of the coverage of stabilizer on the surface of the metal nanoparticles can vary, for example, from partial to full coverage depending on the capability of the stabilizer to stabilize the metal nanoparticles. Of course, there is variability as well in the extent of coverage of the stabilizer among the individual metal nanoparticles. Furthermore, the organic-stabilized metal nanoparticles may have a hydrophobic surface to facilitate release of the flexible stamp.

The weight percentage of the optional stabilizer in the metal nanoparticle composition may be from, for example, about 5 weight percent to about 80 weight percent, from about 10 weight percent to about 60 weight percent or from about 15 weight percent to about 50 weight percent.

In embodiments, the organic-stabilized metal nanoparticles have a hydrophobic surface. This characteristic is important for the process described in present embodiments, wherein the hydrophobic nature of the surface enables aids in the release of deposited metal nanoparticle composition from the flexible stamps. In embodiments, the surface of the metal nanoparticles has a water contact angle greater than 80 degrees, such as, for example, including greater than 90 degrees, and greater than 95 degrees.

Solvent

The metal nanoparticle composition comprised of at least the metal nanoparticles may be produced by dispersing the metal nanoparticles in any suitable dispersing solvent and depositing the metal nanoparticle composition on a substrate to form a conductive feature upon annealing. The composition may be used to print and form conductive features on a substrate.

The dispersing solvent should facilitate the dispersion of the unstabilized or stabilized metal nanoparticles and the low-polarity additive. Examples of the dispersing solvent may include, for example, an alkane or an alcohol having from about 10 to about 18 carbon atoms or from about 10 to about 14 carbon atoms, such as, undecane, dodecane, tridecane, tetradecane, 1-undecanol, 2-undecanol, 3-undecanol, 4-undecanol, 5-undecanol, 6-undecanol, 1-dodecanol, 2-dodecanol, 3-dodecanol, 4-dodecanol, 5-dodecanol, 6-dodecanol, 1-tridecanol, 2-tridecanol, 3-tridecanol, 4-tridecanol, 5-tridecanol, 6-tridecanol, 7-tridecanol, 1-tetradecanol, 2-tetradecanol, 3-tetradecanol, 4-tetradecanol, 5-tetradecanol, 6-tetradecanol, 7-tetradecanol, and the like; a monoterpene alcohol, such as for example, terpineol α-terpineol), β-terpineol, geraniol, cineol, cedral, linalool, 4-terpineol, lavandulol, citronellol, nerol, methol, bomeol, and the like; isoparaffinc hydrocarbons, such as, for example, isodecane, isododecane, and commercially available mixtures of isoparaffins such as ISOPAR E, ISOPAR G, ISOPAR H, ISOPAR L and ISOPAR M (all the above-mentioned manufactured by Exxon Chemical Company), SHELLSOL (made by Shell Chemical Company), SOLTROL (made by Philips Oil Co., Ltd.), BEGASOL (made by Mobil Petroleum Co., Inc.) and IP Solvent 2835 (made by Idemitsu Petrochemical Co., Ltd.); toluene; decalin; xylene; tetrahydrofuran; chlorobenzene; dichlorobenzene; trichlorobenzene; nitrobenzene; cyanobenzene; acetonitrile; dichloromethane; N,N-dimethylformamide (DMF); N-methyl-2-pyrrolidone; and mixtures thereof. Further examples of dispersing solvents include the dispersing solvents disclosed in U.S. patent application Ser. No. 12/331,573, which is incorporated by reference herein in its entirety.

One, two, three or more solvents may be used. In embodiments where two or more solvents are used, each solvent may be present at any suitable volume ratio or molar ratio such, as for example, from about 99 (first solvent):1 (second solvent) to about 1 (first solvent):99 (second solvent), from about 67 (first solvent):33 (second solvent).

The solvent may be present in the composition in an amount of at least 10 weight percent of the composition, such as for example from about 10 weight percent to about 70 weight percent, from about 30 weight percent to about 60 weight percent, from about 30 weight percent to about 55 weight percent and from about 40 weight percent to about 50 weight percent of the composition.

Depositing the Metal Nanoparticle Composition

The metal nanoparticle composition, contained within the flexible stamp, may be deposited to the substrate by any lithographic printing technique, such as “soft lithography.” Examples of soft lithography techniques include near-field phase shift lithography, replica molding (RM), micromolding in capillaries (MIMIC), microtransfer molding (TM), solvent-assisted microcontact molding (SAMIM), microcontact printing (CP), as these techniques offer a relatively simple, fast and cost effective method to produce to sub-micron sized features on large areas.

In embodiments, the metal nanoparticle composition, contained within the flexible stamp, may be deposited to the substrate by the soft lithography technique of micromolding in capillaries. This technique begins by placing the stamp with open channels in it on a metal substrate. By doing this, open channels are formed between the flexible stamp. For example, if the open channel is square-shaped, three sides of the open channel are from the flexible stamp and the bottom side of the channel is from the substrate. Next, the metal nanoparticle composition is placed inside of the flexible stamp to fill the capillaries. The filling of the capillaries relies on the concept called surface free energy. This basically describes how much a material placed into a closed region will attach to a certain surface mainly due to molecular forces. Most materials in the liquid phase have certain forces and opposing forces that keep the liquid in equilibrium; but when a surface of the liquid is exposed to another type of surface such as a solid, the forces change on that surface and cause the liquid to change accordingly. The lower the free energy, the less likely a material will want to stick to it and spread across it. Because the surface free energy of the flexible material in the flexible stamp is lower than that of the substrate, the material being molded will spread across the surface of the substrate more than the surface of the flexible stamp. Once the capillaries have been filled and the metal nanoparticle composition is heated to anneal the metal nanoparticles, the flexible stamp is removed and free-standing structures of conductive traces remain.

The substrate upon which the metal features are deposited may be any suitable substrate, including, for example, silicon, glass plate, plastic film, sheet, fabric, or paper. For structurally flexible devices, plastic substrates, such as for example polyester, polycarbonate, polyimide sheets and the like may be used. The thickness of the substrate may be from amount 10 micrometers to over 10 millimeters with an exemplary thickness being from about 50 micrometers to about 2 millimeters, especially for a flexible plastic substrate and from about 0.4 to about 10 millimeters for a rigid substrate such as glass or silicon.

Annealing

The metal nanoparticle composition may be then heated during or after the deposition of the metal nanoparticles onto the substrate, which induces the metal nanoparticles to “anneal” and thus forms an electrically conductive layer. In one embodiment, the metal nanoparticle composition is heated during the deposition step. For example, both the metal nanoparticles composition and the flexible stamp are heated on the substrate. In another embodiment, the metal nanoparticle composition is heated after the deposition step. For example, the metal nanoparticle composition is heated after removing the flexible stamp. The electrically conductive layer is suitable as an electrically conductive element in electronic devices. For substrates, such as glass, that do not require a low annealing temperature, the deposited metal nanoparticle composition may be heated to a temperature of from about 100° C. to about 350° C., from about 100° C. to about 200° C. and from about 100° C. to about 180° C. However, for other substrates, such as low cost substrates that favor an annealing temperature less than about 200° C., the deposited metal nanoparticle composition may be heated to a temperature of, for example, at or below about 200° C., such as, for example, from about 80° C. to about 200° C., from about 100° C. to about 180° C. and from about 100° C. to about 160° C. Regardless of the substrate used, the heating temperature is one that does not cause adverse changes in the properties of any previously deposited layer(s) or the substrate (whether single layer substrate or multilayer substrate). When both the flexible stamp and the metal nanoparticle composition are heated, the choice of the metal nanoparticles is important so that a low heating temperature of from about 80 to about 200° C. could be used. Such a low heating temperature will not deform the flexible stamp. In embodiments, the organic-stabilized metal nanoparticles are capable of sintering at the low temperature from about 80 to about 200° C. to form highly conductive features.

The heating can be performed for a time ranging from, for example, 0.01 second to about 10 hours and from about 10 seconds to 1 hour. The heating can be performed in air, in an inert atmosphere, for example, under nitrogen or argon, or in a reducing atmosphere, for example, under nitrogen containing from 1 to about 20 percent by volume hydrogen. The heating can also be performed under normal atmospheric pressure or at a reduced pressure of, for example, from about 1000 mbars to about 0.01 mbars.

As used herein, the term “heating” encompasses any technique(s) that can impart sufficient energy to the heated material or substrate to (1) anneal the metal nanoparticles and/or (2) remove the optional stabilizer from the metal nanoparticles. Examples of heating techniques may include thermal heating (for example, a hot plate, an oven, and a burner), infra-red (“IR”) radiation, a laser beam, flash light, microwave radiation, or UV radiation, or a combination thereof.

Heating produces a number of effects. Prior to heating, the layer of the deposited metal nanoparticles may be electrically insulating or with very low electrical conductivity, but heating results in an electrically conductive layer composed of annealed metal nanoparticles, which increases the conductivity. In embodiments, the annealed metal nanoparticles may be coalesced or partially coalesced metal nanoparticles. In embodiments, it may be possible that in the annealed metal nanoparticles, the metal nanoparticles achieve sufficient particle-to-particle contact to form the electrically conductive layer without coalescence.

In embodiments, after heating, the resulting electrically conductive line that has a height or a thickness of at least 1 micron, for example, 1 μm to about 1 mm, from about 1 μm to about 100 μm, from about 1 μm to about 75 μm, from about 1 μm to about 50 μm and from about 1 μm to about 10 μm. However, after heating, the thickness of the electrically conductive line is less than the thickness of the flexible stamp. Furthermore, after heating, the resulting electrically conductive line has a width less than about 200 μm, such as, for example from about 10 μm to about 200 μm, from about 25 μm to about 150 μm, from about 50 μm to about 100 μm and from about 75 μm to about 100 μm. The conductive features, such as metal lines, may have an aspect ratio (the ratio of the width of the conductive features to its height) of from about 3:100 to about 2:1, from about 1:20 to about 1:1, from about 1:10 to about 1:2 and from about 3:100 to about 1:5.

The conductivity of the resulting metal element produced by heating the deposited silver nanoparticle composition is, for example, more than about 100 Siemens/centimeter (“S/cm”), more than about 1000 S/cm, more than about 2,000 S/cm, more than about 5,000 S/cm, or more than about 10,000 S/cm or more than 50,000 S/cm.

The resulting elements can be used as electrodes, conductive pads, interconnect, conductive lines, conductive tracks, and the like in electronic devices such as thin film transistors, organic light emitting diodes, RFD) (radio frequency identification) tags, photovoltaic, displays, printed antenna and other electronic devices which require conductive elements or components.

### EXAMPLES

The examples set forth below are illustrative of different compositions and conditions that can be used in practicing the present embodiments. All proportions are by weight unless otherwise indicated.

### Example 1

### Fabrication of Mold

The master pattern was fabricated using photolitography on a silicon substrate to form a source-drain thin-film transistor electrode patterns with a SU-8 2000 photoresist, manufactured by MicroChem M.A. USA. The master pattern possessed line patterns having a width of 40 microns and a height of 2 microns. A UV-curable urethane pre-polymer solution was prepared by mixing of 19 wt % of EBECRYL resin(urethane acrylates), manufactured by Cytec Industries, 1 wt % of Irgacure 184 (photoinitiator), manufactured by CIBA, and 80 wt % of PGMEA (solvent), manufactured by Aldrich. After stabilizing the pre-polymer solution by removing any bubbles, the pre-polymer solution was then poured into the master pattern to replicate the line patterns of the pattern master and form the electrode patterns of the flexible polyurethane stamp. The coated master was then UV-cured at 10 J/cm² with 350 nm wavelength UV lamp. The flexible urethane mold with replicated pattern was then removed by smooth detaching the flexible urethane mold from the master pattern of the silicon substrate.

### Example 2

### Preparation of Stabilized Silver Nanoparticles

The stabilized silver nanoparticles were prepared by adding 20 grams of silver acetate to dodecylamine (111 g) in a reaction flask flushed with argon at 55° C.-60° C. The mixture was then stirred until the silver acetate was completely dissolved. Subsequently, 7.12 grams of phenylhydrazine was slowly added to the mixture and the resulting mixture was stirred for about one hour at 55° C. Next, The reaction temperature was reduced to about 40° C. and then methanol (400 ml) was added to the resulting mixture to precipitate the dodecylamine-stabilized silver nanoparticles. After stirring the mixture for about 10 minutes at 40° C., the product was collected by filtration and then washed with methanol (˜50 ml). The product was dried under vacuum at room temperature for about 24 hours, yielding about 15.3 grams of dodecylamine stabilized silver nanoparticles. The final product contains about 81.4 weight percent silver and about 18.6 weight percent dodecylamine as the stabilizer.

### Example 3

### Preparation of a Silver Nanoparticle Composition

An silver nanoparticle composition was prepared by adding 0.88 grams of dodecylamine stabilized silver nanoparticles to 0.38 grams of decalin. The silver nanoparticle composition, containing about 70 weight percent silver nanoparticles was then filtered with a 0.45 micron filter.

### Example 4

### Forming Conductive Feature

The conductive feature was formed using the soft lithography technique of micromolding by capillaries. The flexible stamp was placed on a pre-cleaned glass substrate and subsequently filled by injecting the silver metal nanoparticle composition into the flexible stamp via the soft lithography technique of micromolding in capillaries. The metal nanoparticle composition within the flexible stamp was then heated in an oven to a temperature of 130° C. for 30 minutes to anneal the silver nanoparticles and form a shiny mirror-like thin film with an average height or thickness of approximately 1.5 microns. The average conductivity of the annealed silver film was 1.41×10⁴ S/cm, as measured by KEITHLEY 4-Probes.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of forming conductive features on a substrate, the method comprising:
filling a flexible stamp with a metal nanoparticle composition,
depositing the metal nanoparticle composition onto the substrate, and
heating the metal nanoparticle composition during or after the depositing to form the conductive features.

2. The method of claim 1, wherein the conductive features have a thickness of at least 1 micron.

3. The method of claim 1, wherein the flexible stamp comprises a material selected from the group consisting of polysiloxane, polyurethane, polyester, fluoro elastomer, silicon elastomer, fluorinated polymers, and mixtures thereof.

4. The method of claim 1, wherein the flexible stamp comprises a urethane having a curable group selected from the group consisting of an acrylate, methacrylate, alkene, allylic ether, epoxide and oxetane.

5. The method of claim 1, wherein the flexible stamp includes a relief pattern of the conductive feature to be formed on the substrate.

6. The method of claim 1, wherein the filling further comprises injecting the metal nanoparticle composition into the flexible stamp.

7. The method of claim 1, wherein the metal nanoparticle composition comprises metal nanoparticles, a stabilizer and a solvent.

8. The method of claim 7, wherein the metal nanoparticle composition contains at least 50 weight percent metal nanoparticles.

9. The method of claim 7, wherein the metal nanoparticles are selected from the group consisting of silver, gold, platinum, palladium, copper, cobalt, chromium, nickel, silver-copper composite, silver-gold-copper composite, silver-gold-palladium composite and mixtures thereof.

10. The method of claim 7, wherein the stabilizer is an organoamine stabilizer selected from the group consisting butylamine, pentylamine, hexylamine, heptylamine, octylamine, nonylamine, decylamine, hexadecylamine, undecylamine, dodecylamine, tridecylamine, tetradecylamine, diaminopentane, diaminohexane, diaminoheptane, diaminooctane, diaminononane, diaminodecane, diaminooctane, dipropylamine, dibutylamine, dipentylamine, dihexylamine, diheptylamine, dioctylamine, dinonylamine, didecylamine, methylpropylamine, ethylpropylamine, propylbutylamine, ethylbutylamine, ethylpentylamine, propylpentylamine, butylpentylamine, tributylamine, trihexylamine and mixtures thereof.

11. The method of claim 1, wherein the conductive features are metal lines having a aspect ratio of from about 3:100 to about 2:1.

12. The method of claim 1, wherein the depositing is a molding technique selected from the group consisting of replica molding, microtransfer molding, micromolding in capillaries and solvent-assisted molding.

13. The method of claim 1, wherein the deposited metal nanoparticle composition is heated to a temperature of from about 80° C. to about 200° C.

14. A method of forming conductive features on a substrate, the method comprising:
filling a flexible stamp with a metal nanoparticle composition comprised of organic-stabilized metal nanoparticles and a solvent,
depositing the metal nanoparticle composition onto the substrate, and
heating the deposited metal nanoparticle composition during or after the depositing to a temperature of from about 80° C. to about 200° C. to form the conductive features.

15. The method of claim 14, wherein the flexible stamp comprises a material selected from the group consisting of polysiloxane, polyurethane, polyester, fluoro elastomer, silicon elastomer, fluorinated polymers, and mixtures thereof.

16. The method of claim 14, wherein the metal nanoparticle composition has a viscosity of at least 10 cps.

17. The method of claim 14, wherein the metal nanoparticles are selected from the group consisting of silver, gold, platinum, palladium, copper, cobalt, chromium, nickel, silver-copper composite, silver-gold-copper composite, silver-gold-palladium composite and mixtures thereof.

18. The method of claim 14, wherein a stabilizer in the organic-stabilized metal nanoparticles is selected from the group consisting of an organoamine, a carboxylic acid, a xanthic acid and a thiol, and the organic-stabilized metal nanoparticles have a hydrophobic surface.

19. The method of claim 14, wherein the conductive features have a thickness of at least 1 micron.

20. The method of claim 14, wherein the depositing is a molding technique selected from the group consisting of replica molding, microtransfer molding, micromolding in capillaries and solvent-assisted molding.
